(19) United States
(12) Patent Application Publication
(10) Pub. No.: US 2026/0213275 A1
(43) Pub. Date: Jul. 23, 2026

(54) BATTERY MODULE AND METHOD FOR MANUFACTURING THE SAME

(71) Applicant: Toyota Jidosha Kabushiki Kaisha, Toyota-shi (JP)

(72) Inventors: Hiroyuki NAKAYAMA, Okazaki-shi (JP); Shuichi Nishida, Miyoshi-shi (JP)

(73) Assignee: Toyota Jidosha Kabushiki Kaisha, Toyota-shi (JP)

(21) Appl. No.: 19/416,232

(22) Filed: Dec. 11, 2025

(30) Foreign Application Priority Data
Jan. 22, 2025 (JP) 2025009103

(51) Int. Cl. H01M 10/0585; H01M 4/02; H01M 10/0525; H01M 10/613; H01M 10/653; H01M 50/51

(52) U.S. Cl. CPC H01M 10/0585; H01M 10/613; H01M 10/653; H01M 50/51; H01M 2004/029; H01M 10/0525

(57) ABSTRACT

In a method for manufacturing a battery module, a first laminate is formed by sealing, with a sealing material, the periphery of a region from one outermost electrode foil to one bipolar electrode foil of the battery module. A second laminate is formed by sealing, with the sealing material, the periphery of a region from the other outermost electrode foil to one electrolyte layer of the battery module, namely to one electrolyte layer that is to face the one bipolar electrode foil. The first laminate and the second laminate are stacked on top of each other, and a thermally conductive foil is heated to thermally weld the seal portion to the thermally conductive foil.

### CROSS-REFERENCE TO RELATED APPLICATION

This application claims priority to Japanese Patent Application No. 2025-009103 filed on Jan. 22, 2025. The disclosure of the above-identified application, including the specification, drawings, and claims, is incorporated by reference herein in its entirety.

### BACKGROUND

### 1. Technical Field

The present disclosure relates to battery modules used in energy storage devices

and to methods for manufacturing the same, and more particularly, to a structure for cooling the battery module.

### 2. Description of Related Art

Secondary batteries such as lithium-ion secondary batteries, which are used in energy storage devices, generally have a laminated structure. In this structure, a cathode active material layer coated on a current collector foil (cathode foil) (which may be a metal foil), and an anode active material layer coated on a current collector foil (anode foil) (which may be a metal foil) face each other across a separator immersed in an electrolyte solution (in the case of liquid batteries) or across a solid electrolyte layer (in the case of all-solid-state batteries). Various configurations have been proposed to address issues that can arise in such secondary batteries. For example, Japanese Unexamined Patent Application Publication No. 2023-177537 (JP 2023-177537 A) proposes an energy storage device configured to suppress damage to an energy storage stack when the energy storage device is subjected to external impact. The energy storage device includes: an energy storage stack including a plurality of energy storage modules arranged in a first direction; a pair of restraint plates sandwiching the energy storage stack in the first direction; a pair of side walls that faces each other in a second direction perpendicular to the first direction such that the energy storage stack is positioned therebetween; and a plurality of stoppers disposed between the energy storage stack and the pair of side walls on both outer sides of the energy storage stack in the second direction. Each of the restraint plates has an outer main surface on the opposite side from the energy storage stack. The outer main surface of each restraint plate is provided with a plurality of reinforcing portions extending in the second direction and arranged in a third direction perpendicular to the first and second directions. The stoppers are disposed at both ends of each reinforcing portion in the second direction, and each stopper is located at a position overlapping a corresponding one of the reinforcing portions in the first direction. Japanese Unexamined Patent Application Publication No. 2005-71784 (JP 2005-71784 A) proposes a stacked battery in which a plurality of cells is stacked and connected in series. To suppress voltage fluctuations caused by heat buildup, improve battery characteristics, and extend battery life, cooling tabs are attached to a plurality of current collectors. Among these, the cooling tab located at the central position in the thickness direction of the stacked current collectors exhibits the greatest heat dissipation, which gradually decreases toward both ends in the thickness direction.

### SUMMARY

As a battery module for the above type of secondary battery, a configuration is known in which a plurality of laminated structures, each sandwiched between a cathode foil and an anode foil, are stacked to form a module. Except for the outermost electrode foils of the module, each cathode foil is integrated with the anode foil of its adjacent laminated structure and each anode foil is integrated with the cathode foil of its laminated structure, thereby forming “bipolar electrode foils.” An electrolyte layer is interposed between each pair of bipolar electrode foils. Since a battery module generates heat during operation, it is desirable to cool it as appropriate. In a module in which a plurality of bipolar electrode foils is stacked with an active material layer and an electrolyte layer interposed between them, simply cooling the outermost cell by bringing a cooler into contact with it may not be sufficient. Depending on the thermal conductivity and cooling performance in the thickness direction of the stacked cells, heat may not be sufficiently removed from the inner cells. In such cases, the inner cells may not be sufficiently cooled, leading to heat buildup, elevated internal temperatures, and accelerated degradation.

As described above, regarding a structure in which a plurality of cells is stacked by interposing an active material layer and an electrolyte layer between each pair of bipolar electrode foils, various approaches have been proposed to cool the inner cells. In one approach, the bipolar electrode foil of an inner cell (or, as in JP 2005-71784 A, a tab connected to the bipolar electrode foil) is extended beyond the seal portion that seals the electrolyte layer at the periphery of the cell such that the bipolar electrode foil (or the tab) protrudes outward in the planar direction of the cell. The protruding portion is then cooled. In this regard, when the bipolar electrode foil or the tab is configured to protrude outward from the seal portions on both sides of the cell in the planar direction, it is necessary to form a structure that ensures reliable sealing of the electrolyte layer-side region at the seal portions even though the foil or the tab passes through the seal portions. In particular, in the case of liquid battery cells, if sealing at the locations where the bipolar electrode foil or the tab passes through the seal portions is incomplete, electrolyte solution may leak from those locations.

In view of the above circumstances, a primary object of the present disclosure is to ensure reliable sealing of a portion of a bipolar electrode foil that passes through a seal portion. Specifically, in order to cool inner cells of a battery module (a stack of a plurality of cells) in which a plurality of bipolar electrode foils is laminated, an inner bipolar electrode foil is configured to protrude outward in a planar direction beyond a seal portion that seals electrolyte layers along the peripheries of the cells, and the protruding portion is cooled. The primary object is to enable reliable sealing of the portion of the bipolar electrode foil that passes through the seal portion in such a configuration.

According to the present disclosure, the above object is achieved by the following method: a method for manufacturing a battery module in which a plurality of cells is stacked, each of the cells including a cathode active material layer coated on an electrode foil serving as a cathode foil and an anode active material layer coated on an electrode foil serving as an anode foil, the cathode active material layer and the anode active material layer facing each other across an electrolyte layer, the electrode foils being configured such that, except for one outermost electrode foil and the other outermost electrode foil of the battery module, the cathode foil of each of the cells is integrated with the anode foil of an adjacent cell to constitute a bipolar electrode foil and the anode foil of each of the cells is integrated with the cathode foil of an adjacent cell to constitute a bipolar electrode foil, the cells being connected in series, and a seal portion being provided that seals, with a thermally weldable sealing material, a region from the one outermost electrode foil to the other outermost electrode foil of the battery module along peripheries of the electrode foils and the electrolyte layers, the method including:
forming a first laminate by (i) laminating the electrode foils, each coated with the cathode active material layer and the anode active material layer, and the electrolyte layers from the one outermost electrode foil to one bipolar electrode foil of the battery module, and (ii) sealing, with the sealing material, a periphery of a region from the one outermost electrode foil to the one bipolar electrode foil of the battery module to form a first part of the seal portion, the forming the first laminate including (a) forming the one bipolar electrode foil such that the one bipolar electrode foil protrudes outward in at least one planar direction of the one bipolar electrode foil beyond a region sealed with the sealing material, (b) thermally welding the sealing material to a strip-shaped region of an outer surface of the one bipolar electrode foil where the seal portion is to be located, and (c) further thermally welding a thermally conductive foil to an outer side of the sealing material;
forming a second laminate by (i) laminating the electrode foils, each coated with the cathode active material layer and the anode active material layer, and the electrolyte layers from the other outermost electrode foil to one electrolyte layer of the battery module that is to face the one bipolar electrode foil, and (ii) sealing, with the sealing material, a periphery of a region from the other outermost electrode foil to the one electrolyte layer of the battery module to form a second part of the seal portion;
stacking the first laminate and the second laminate on top of each other such that the thermally conductive foil of the first laminate comes into contact with a surface of the second part of the seal portion of the second laminate; and
heating the thermally conductive foil to thermally weld the thermally conductive foil and the sealing material in the strip-shaped region of the second laminate.

In the above configuration, the “battery module” may be a battery module of a secondary battery such as a lithium-ion secondary battery, and as described above, may be a battery module in which a plurality of cells is stacked, each of the cells including a cathode active material layer coated on an electrode foil serving as a cathode foil and an anode active material layer coated on an electrode foil serving as an anode foil, the cathode active material layer and the anode active material layer facing each other across an electrolyte layer, the electrode foils being configured such that, except for one outermost electrode foil and the other outermost electrode foil of the battery module, the cathode foil of each of the cells is integrated with the anode foil of an adjacent cell to constitute a bipolar electrode foil and the anode foil of each of the cells is integrated with the cathode foil of an adjacent cell to constitute a bipolar electrode foil, the cells being connected in series, and a seal portion being provided that seals, with a thermally weldable sealing material, a region from the one outermost electrode foil to the other outermost electrode foil of the battery module along peripheries of the electrode foils and the electrolyte layers. The cathode foil, the cathode active material layer, the anode foil, the anode active material layer, the separator, the electrolyte solution, and the thermally weldable sealing material may be of types commonly used in the art. In such a battery module, particularly in the present disclosure, in order to cool inner cells of the battery module, any intermediate one of the bipolar electrode foils of the battery module has a portion that protrudes outward in the planar direction through the seal portion along the periphery of the battery module, and this protruding portion is cooled. This allows heat to be released from the inner cells of the battery module as well, thereby suppressing battery degradation.

In the case of a configuration in which an intermediate bipolar electrode foil of the battery module protrudes through the seal portion as described above, if all of the electrode assemblies (electrode foils coated with active material layers) and the electrolyte layers to be laminated in the battery module are laminated and the periphery of the resulting laminate is thermally welded with a sealing material, the sealing with the sealing material may become insufficient at the portion where the bipolar electrode foil protrudes beyond the seal portion. More specifically, as shown in FIG. 3A, when the electrode assemblies to be laminated in a battery module 1 (electrode assemblies 2a-3 and 2b-4 on both sides of the battery module and bipolar electrode assemblies 4-2-3 therebetween) and electrolyte layers 5 are laminated (with spacers 7 optionally interposed between the electrode foils) and the periphery of the resulting laminate is thermally welded with sealing materials 6, 6a, a process is generally employed in which a thermally weldable sealing material 6a is disposed along the peripheries of the electrode foils and the electrolyte layers and heated by infrared (IR) radiation (IR welding). However, as shown in FIG. 3B, when an intermediate bipolar electrode foil 2X of the battery module 1 protrudes beyond the seal portion 6a, there is a portion x where the infrared light (IR) that should be emitted to the seal portion 6a is blocked by the protruding bipolar electrode foil 2X, and the thermal welding of the sealing material by the infrared light becomes insufficient in that portion x.

Accordingly, in the present disclosure, in brief, a portion on one side and a portion on the other side of a bipolar electrode foil protruding beyond a seal portion of a battery module are fabricated separately, and then stacked on top of each other to complete the battery module.

Specifically, as described above, as one part of a battery module, a first laminate is formed by (i) laminating electrode assemblies (electrode foils, each coated with a cathode active material layer and an anode active material layer) and electrolyte layers from one outermost electrode foil to one bipolar electrode foil of the battery module, and (ii) sealing, with the sealing material, the periphery of a region from the one outermost electrode foil to the one bipolar electrode foil of the battery module to form a first part of the seal portion. In this case, the first laminate is formed by (a) forming the one bipolar electrode foil such that the one bipolar electrode foil protrudes outward in at least one planar direction of the one bipolar electrode foil beyond a region sealed with the sealing material, (b) thermally welding the sealing material to a strip-shaped region of an outer surface of the one bipolar electrode foil where the seal portion is to be located, and (c) further thermally welding a thermally conductive foil to an outer side of the sealing material. The thermally conductive foil may be a foil member formed of a material that conducts heat, such as a metal foil, and is bonded to the entire surface of the sealing material in the strip-shaped region.

As the other part of the battery module, a second laminate is formed by (i) laminating electrode assemblies (electrode foils, each coated with a cathode active material layer and an anode active material layer) and electrolyte layers from the other outermost electrode foil to one electrolyte layer of the battery module that is to face the one bipolar electrode foil, and (ii) sealing, with the sealing material, the periphery of a region from the other outermost electrode foil to the one electrolyte layer of the battery module to form a second part of the seal portion.

Thereafter, the first laminate and the second laminate are stacked on top of each other such that the thermally conductive foil of the first laminate comes into contact with the surface of the second part of the seal portion of the second laminate. The thermally conductive foil is then heated. The heating of the thermally conductive foil may be achieved, for example, by bringing a high-temperature member into contact with the thermally conductive foil, or by passing a current through the thermally conductive foil to generate Joule heat. When the thermally conductive foil is heated, heat is conducted through the thermally conductive foil, causing the sealing material on the surface of the second part of the seal portion of the second laminate, which is in contact with the thermally conductive foil, to melt. As a result, the thermally conductive foil and the surface of the second part of the seal portion of the second laminate are thermally welded together. In this way, the outer surface of the one bipolar electrode foil protruding beyond the seal portion of the first laminate and the outer surface of the one electrolyte layer of the second laminate can be sufficiently sealed with the sealing material. Accordingly, the portion of the bipolar electrode foil passing through the seal portion can be reliably sealed.

In the above configuration, the electrolyte layer may be a solid electrolyte layer. In the case of a liquid battery, the electrolyte layer may be a separator that is impregnated with an electrolyte solution. In the case of a liquid battery, after the periphery of the laminated structure of the electrode assemblies and the separators are sealed with a sealing material to form a seal portion, an injection port for injecting the electrolyte solution is attached by any method. The electrolyte solution is then injected through the injection port, and the spaces between the electrode assemblies are filled with the electrolyte solution. In that case, according to the present disclosure, even though an intermediate bipolar electrode foil of the battery module protrudes through the seal portion, the sealing material around the region where the intermediate bipolar electrode foil passes through the seal portion is satisfactorily thermally welded to the bipolar electrode foil to provide sealing. As a result, the electrolyte solution can be retained between the electrode assemblies.

In a case where the battery module is a liquid battery module, an injection port for the electrolyte solution is formed on one side of the battery module, and on the other sides of the battery module, a bipolar electrode foil may protrude beyond the seal portion. That is, in the configuration of the present disclosure, one bipolar electrode foil may protrude outward beyond the region sealed with the sealing material in all planar directions except a direction in which an injection port for the electrolyte solution is formed. Accordingly, it is expected that the battery module can be cooled more effectively.

According to the above configuration, in a battery module in which one intermediate bipolar electrode foil protrudes beyond the sealed portion, the protruding bipolar electrode foil is welded to the seal portion via a thermally conductive foil. Another aspect of the present disclosure provides a battery module in which a plurality of cells is stacked, each of the cells including a cathode active material layer coated on an electrode foil serving as a cathode foil and an anode active material layer coated on an electrode foil serving as an anode foil, the cathode active material layer and the anode active material layer facing each other across an electrolyte layer, the electrode foils being configured such that, except for one outermost electrode foil and the other outermost electrode foil of the battery module, the cathode foil of each of the cells is integrated with the anode foil of an adjacent cell to constitute a bipolar electrode foil and the anode foil of each of the cells is integrated with the cathode foil of an adjacent cell to constitute a bipolar electrode foil, the cells being connected in series, and a seal portion being provided that seals, with a thermally weldable sealing material, a region from the one outermost electrode foil to the other outermost electrode foil of the battery module along peripheries of the electrode foils and the electrolyte layers, wherein
one of the bipolar electrode foils includes a portion protruding outward in a planar direction beyond the seal portion, and the seal portion on one surface of the one bipolar electrode foil is welded via a thermally conductive foil. In this battery module, the cells may be liquid battery cells, and the electrolyte layer may be a separator to be impregnated with an electrolyte solution.

Thus, according to the configuration of the present embodiment, in order to cool inner cells of the battery module in which the cells are stacked, an inner bipolar electrode foil is configured to protrude outward in the planar direction beyond the seal portion that seals the electrolyte layers along the peripheries of the cells, and the protruding portion is cooled. In such a configuration, the portion of the bipolar electrode foil that passes through the seal portion can be reliably sealed with the sealing material. The configuration of the present disclosure may be applied to battery modules of various configurations in which a bipolar electrode foil protrudes beyond a sealing member.

Other objects and advantages of the present disclosure will become apparent from the following description of preferred embodiments.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic top view of a battery module to which an embodiment of the present disclosure is applied;

FIG. 1B is a schematic sectional view of the battery module to which the embodiment is applied, taken along line B-B in FIG. 1A;

FIG. 2A is a schematic bottom view of a first laminate of the battery module to which the embodiment is applied;

FIG. 2B is a schematic sectional view, taken along line B-B in FIG. 2A;

FIG. 2C is a schematic sectional view of a second laminate of the battery module to which the embodiment is applied;

FIG. 2D is a schematic partial sectional view of a battery module illustrating a state in which the first and second laminates are stacked on top of each other and their seal portions are thermally welded via a thermally conductive foil;

FIG. 3A is a partial sectional view of a standard battery module, schematically illustrating a process of sealing the periphery of the battery module with a seal portion; and

FIG. 3B is a partial sectional view of the battery module to which the embodiment is applied, schematically illustrating a process of sealing the periphery of the battery module with a seal portion.

### DETAILED DESCRIPTION OF EMBODIMENTS

Hereinafter, preferred embodiments of the present disclosure will be described in detail with reference to the accompanying drawings. The same signs denote the same portions throughout the drawings.

### Configuration of Battery Module

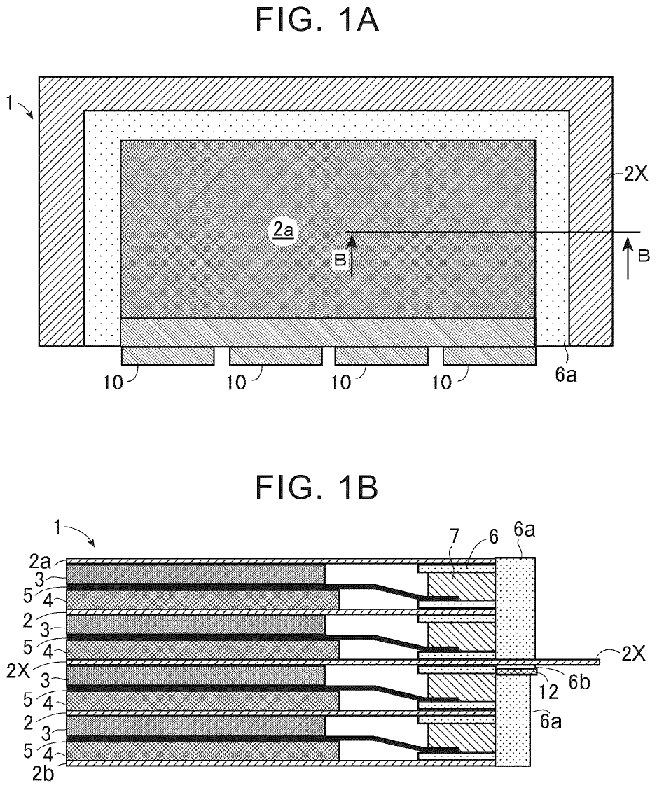

The battery module to which the present embodiment is applied may basically be a battery module in a standard form such as a lithium-ion secondary battery module. Referring to FIGS. 1A and 1B, a battery module 1 has a configuration in which a plurality of cells is stacked. In each cell, a cathode active material layer 3 coated on the surface of a positive electrode foil (cathode foil) 2, 2a and an anode active material layer 4 coated on the surface of a negative electrode foil (anode foil) 2, 2b face each other across an electrolyte layer. In the case of a liquid battery, the electrode layer is formed by sandwiching a separator 5 between the electrode foils and filling the space therebetween with an electrolyte solution. In the case of an all-solid-state battery, the electrode layer is a solid electrolyte layer (not shown). Except for the outermost electrode foils 2a, 2b of the battery module 1, each cathode foil is integrated with the anode foil of its adjacent cell and each anode foil is integrated with the cathode foil of its adjacent cell through adhesion etc., thereby forming bipolar electrode foils 2. Both sides of each bipolar electrode foil 2 are coated with a cathode active material layer 3 and an anode active material layer 4 to form a bipolar electrode assembly. The periphery of each electrode foil 2, 2a, 2b is covered with a primary seal 6. As shown in FIG. 1B, spacers 7 may be interposed between the electrode foils 2, 2a, 2b to maintain the spacing therebetween. In the case of a liquid battery, the regions between the electrode foils 2, 2a, 2b are sealed with a thermally weldable sealing material to form a seal portion 6a. This sealing is performed along the peripheries of the electrode foils 2, 2a, 2b and the corresponding electrolyte layer (separator 5), except at the edge where an injection port 10 for an electrolyte solution as shown in FIG. 1A is to be provided (the lower edge in FIG. 1A) (in the case of an all-solid-state battery, all peripheral edges between each electrode foil 2, 2a, 2b and the corresponding electrolyte layer (separator 5) may be sealed with the sealing material). In the above configuration, the electrode foils, the cathode and anode active material layers, the electrolyte layers (the separators 5 and the electrolyte solution), and the seal portion formed by the sealing material may, except as otherwise described below, be made of materials commonly used in the art and formed in a standard manner (see, for example, Japanese Unexamined Patent Application Publication No. 2024-42569 (JP 2024-42569 A)). After the edges other than the edge where the injection port 10 is to be provided have been sealed with the seal portion, the injection port 10 may be formed by any method (for example, by the injection molding method described in Japanese Unexamined Patent Application Publication No. 2024-88396 (JP 2024-88396 A)).

In addition to the basic configuration of the battery module 1 described above, in the present embodiment, one of the bipolar electrode foils laminated in the battery module 1, namely a bipolar electrode foil 2X, is configured to have a portion that extends outward in the planar direction beyond the seal portion 6a along the periphery of the battery module 1, as shown in FIGS. 1A and 1B. The protruding portion of the bipolar electrode foil 2X may be provided along all edges where the seal portion 6a is formed. With this configuration, since the bipolar electrode foil 2X is a metal foil with high thermal conductivity, cooling the protruding portion of the bipolar electrode foil 2X makes it possible to absorb heat from inside the battery module 1 and therefore suppress degradation of the battery module.

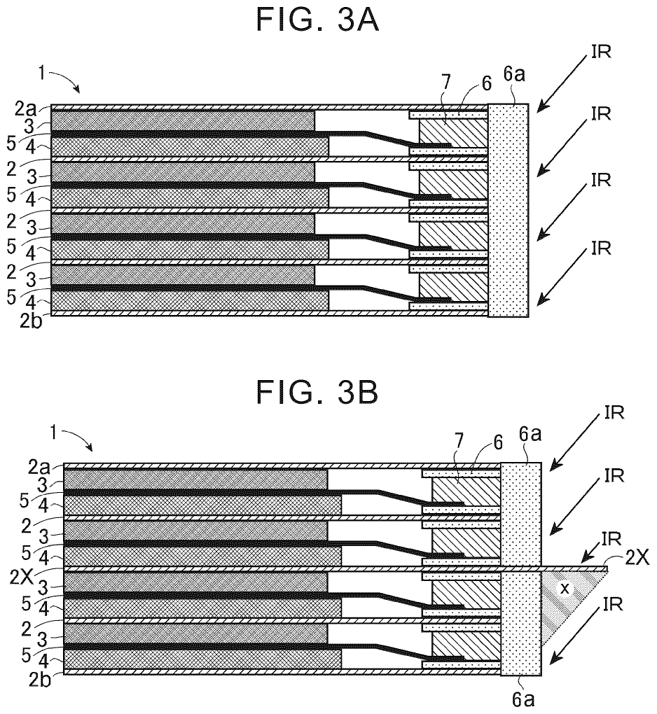

However, as explained in the section “SUMMARY OF THE DISCLOSURE”(see FIG. 3B), when an intermediate bipolar electrode foil 2X of the battery module 1 protrudes outward beyond the seal portion 6a, forming the entire seal portion 6a at once by thermally welding the sealing material with IR welding may present difficulties. Some areas around the bipolar electrode foil 2X may not be reached by the infrared radiation, making it difficult to achieve sufficient sealing of the seal portion.

Accordingly, as will be described in detail later, the present embodiment employs the following method. The portion from one outermost electrode foil 2a to the bipolar electrode foil 2X of the battery module 1 (the portion above the bipolar electrode foil 2X in FIG. 1B) and the remaining portion of the battery module 1 (the portion below the bipolar electrode foil 2X in FIG. 1B) are formed separately. These portions are then stacked on top of each other, and the bipolar electrode foil 2X and the seal portion 6a of the remaining portion are thermally welded using a different method. For this purpose, in the battery module according to the present embodiment, as shown in FIG. 1B, a sealing material 6b and a thermally conductive foil 12 are interposed in the strip-shaped region between the bipolar electrode foil 2X and the seal portion 6a of the remaining portion.

### Manufacturing of Battery Module

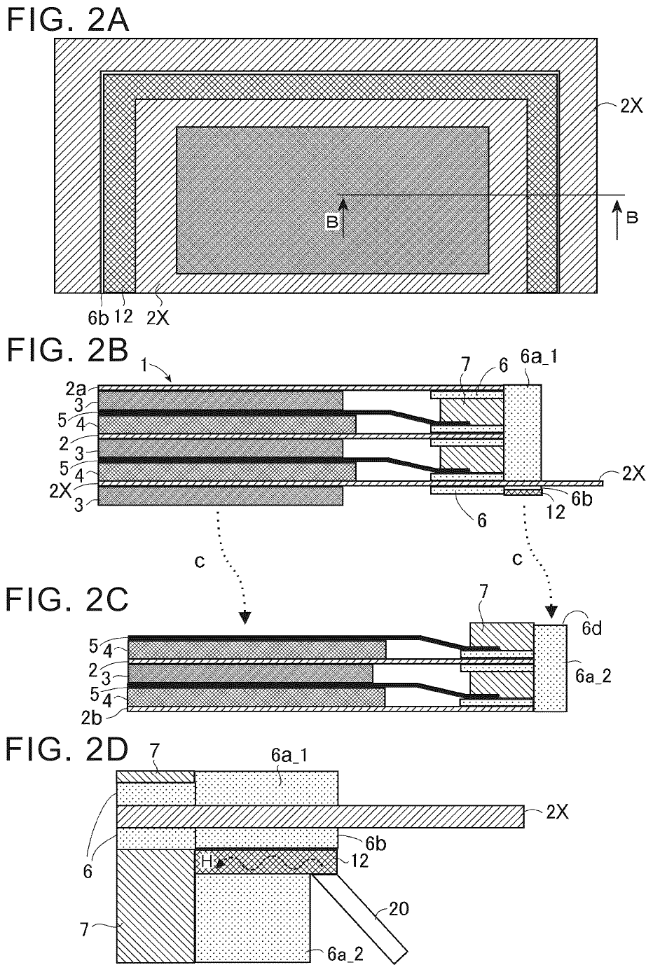

As described above, in the manufacturing method of the battery module according to the present embodiment, a first laminate and a second laminate are fabricated separately. As schematically shown in FIGS. 2A and 2B, the first laminate is a portion from one outermost electrode foil 2a of the battery module 1 to the bipolar electrode foil 2X. As schematically shown in FIG. 2C, the second laminate is a portion from the electrolyte layer (separator 5) that will face the bipolar electrode foil 2X to the other outermost electrode foil 2b of the battery module 1. Here, the steps up to the lamination of the electrode assemblies and the electrolyte layers in the first and second laminates may be performed in a standard manner. The step of forming seal portions 6a_1, 6a_2 by thermally welding the sealing material along the peripheries of the electrode foils and the electrolyte layers may be performed using a standard IR welding method. As shown in the figures, the bipolar electrode foil 2X of the first laminate may be formed so as to extend outward in the planar direction beyond the seal portion 6a-1 along all edges except the edge where an injection port will later be provided. Furthermore, as shown in the figures, the sealing material 6b having a strip shape is thermally welded to a region of the outer surface of the bipolar electrode foil 2X (the lower surface in the figures), namely in a region with which the surface 6d of the seal portion 6a_2 (the upper surface in FIG. 2C) will come into contact when the first laminate and the second laminate are stacked on top of each other. In addition, a foil made of a material with high thermal conductivity (thermally conductive foil 12) is thermally welded to the surface of the sealing material 6b. The welding of the sealing material 6b and the thermally conductive foil 12 in this strip-shaped region may be achieved by any method such as irradiating infrared light from below in the figure.

Thereafter, as indicated by the dotted arrows c in FIGS. 2B and 2C, the first laminate and the second laminate are stacked on top of each other such that the thermally conductive foil 12 of the first laminate comes into contact with the surface 6d of the seal portion 6a_2 of the second laminate and the active material layer 3 on the outer surface of the bipolar electrode foil 2X of the first laminate faces the separator 5 of the second laminate (as in the state shown in FIG. 1B). The thermally conductive foil 12 is then heated. As shown in FIG. 2D, the heating of the thermally conductive foil 12 may be achieved, for example, by bringing a high-temperature member 20 into contact with the thermally conductive foil 12, or by passing a current through the thermally conductive foil 12 to generate Joule heat.

As a result, as shown in FIG. 2D, heat H is conducted along the thermally conductive foil 12. Since the surface 6d of the seal portion 6a_2 is in contact with the thermally conductive foil 12, the seal material of the surface 6d melts and is thermally welded to the thermally conductive foil 12. In this way, both sides of the bipolar electrode foil 2X and the seal portions 6a are sealed. That is, even when an intermediate bipolar electrode foil of the battery module protrudes outward in the planar direction through the seal portion, the region on the electrolyte layer side can be reliably sealed from the outside by the sealing material. In the case of a liquid battery, the injection port 10 is formed at the edge where no seal portion is provided, and the electrolyte is injected through this port.

Thus, according to the present embodiment, in order to cool the inner cells of the battery module in which the cells are stacked, the inner bipolar electrode foil is configured to protrude outward in the planar direction beyond the seal portion that seals the electrolyte layers along the peripheries of the cells, and the protruding portion is cooled. In such a configuration, the portion of the bipolar electrode foil that passes through the seal portion can be reliably sealed with the sealing material.

While the disclosure has been described in connection with the embodiments, numerous modifications and variations will be readily apparent to those skilled in the art. It is therefore to be understood that the present disclosure is not limited to the embodiments illustrated above and may be applied to various devices without departing from the spirit and scope of the disclosure.

What is claimed is:

1. A method for manufacturing a battery module in which a plurality of cells is stacked, each of the cells including a cathode active material layer coated on an electrode foil serving as a cathode foil and an anode active material layer coated on an electrode foil serving as an anode foil, the cathode active material layer and the anode active material layer facing each other across an electrolyte layer, the electrode foils being configured such that, except for one outermost electrode foil and the other outermost electrode foil of the battery module, the cathode foil of each of the cells is integrated with the anode foil of an adjacent cell to constitute a bipolar electrode foil and the anode foil of each of the cells is integrated with the cathode foil of an adjacent cell to constitute a bipolar electrode foil, the cells being connected in series, and a seal portion being provided that seals, with a sealing material that is thermally weldable, a region from the one outermost electrode foil to the other outermost electrode foil of the battery module along peripheries of the electrode foils and the electrolyte layers, the method comprising:
forming a first laminate by (i) laminating the electrode foils, each coated with the cathode active material layer and the anode active material layer, and the electrolyte layers from the one outermost electrode foil to one bipolar electrode foil of the battery module, and (ii) sealing, with the sealing material, a periphery of a region from the one outermost electrode foil to the one bipolar electrode foil of the battery module to form a first part of the seal portion, the forming the first laminate including (a) forming the one bipolar electrode foil such that the one bipolar electrode foil protrudes outward in at least one planar direction of the one bipolar electrode foil beyond a region sealed with the sealing material, (b) thermally welding the sealing material to a strip-shaped region of an outer surface of the one bipolar electrode foil where the seal portion is to be located, and (c) further thermally welding a thermally conductive foil to an outer side of the sealing material;
forming a second laminate by (i) laminating the electrode foils, each coated with the cathode active material layer and the anode active material layer, and the electrolyte layers from the other outermost electrode foil to one electrolyte layer of the battery module that is to face the one bipolar electrode foil, and (ii) sealing, with the sealing material, a periphery of a region from the other outermost electrode foil to the one electrolyte layer of the battery module to form a second part of the seal portion;
stacking the first laminate and the second laminate on top of each other such that the thermally conductive foil of the first laminate comes into contact with a surface of the second part of the seal portion of the second laminate; and
heating the thermally conductive foil to thermally weld the thermally conductive foil and the sealing material in the strip-shaped region of the second laminate.

2. The method according to claim 1, wherein the one bipolar electrode foil serves as the electrode foil of two intermediate ones of the cells of the battery module.

3. The method according to claim 1, wherein the cells are liquid battery cells, and the electrolyte layer is a separator to be impregnated with an electrolyte solution.

4. The method according to claim 3, wherein the one bipolar electrode foil protrudes outward beyond the region sealed with the sealing material in all planar directions except a direction in which an injection port for the electrolyte solution is formed.

5. A battery module in which a plurality of cells is stacked, each of the cells including a cathode active material layer coated on an electrode foil serving as a cathode foil and an anode active material layer coated on an electrode foil serving as an anode foil, the cathode active material layer and the anode active material layer facing each other across an electrolyte layer, the electrode foils being configured such that, except for one outermost electrode foil and the other outermost electrode foil of the battery module, the cathode foil of each of the cells is integrated with the anode foil of an adjacent cell to constitute a bipolar electrode foil and the anode foil of each of the cells is integrated with the cathode foil of an adjacent cell to constitute a bipolar electrode foil, the cells being connected in series, and a seal portion being provided that seals, with a sealing material that is thermally weldable, a region from the one outermost electrode foil to the other outermost electrode foil of the battery module along peripheries of the electrode foils and the electrolyte layers,
wherein one of the bipolar electrode foils includes a portion protruding outward in a planar direction beyond the seal portion, and the seal portion on one surface of the one bipolar electrode foil is welded via a thermally conductive foil.
